(19) United States
(12) Patent Application Publication
(10) Pub. No.: US 2013/0124243 A1
(43) Pub. Date: May 16, 2013

(54) SYSTEM AND METHOD FOR CREATING DOCUMENTS TO MANAGE A PROPOSAL LIFECYCLE

(71) Applicants: Christopher Scot JOHNSON, Great Falls, VA (US); Michael BRANSON, Herndon, VA (US)

(72) Inventors: Christopher Scot JOHNSON, Great Falls, VA (US); Michael BRANSON, Herndon, VA (US)

(73) Assignee: i3solutions, Sterling, VA (US)

(21) Appl. No.: 13/296,822

(22) Filed: Nov. 15, 2011

(51) Int. Cl. G06Q 10/06

(52) U.S. Cl. 705/7.12; 705/342

(57) ABSTRACT

The system and method described herein may integrate an enterprise proposal management system with various enterprise systems, applications, data sources, and other resources to provide a comprehensive solution to manage and coordinate a proposal lifecycle and data associated therewith. In particular, the system and method described herein may integrate and use business information stored in various data sources to execute repeatable and effective strategies to manage business development and proposal efforts, reduce the time that proposal authors spend to search, retrieve, and use content from past proposals to create proposals likely to win new business, coordinate collaboration across organizational teams involved in managing proposal, reliably track capture and proposal pipelines, and preserve documents, data, and other information relevant to the proposal lifecycle, thereby providing real business value in day-to-day proposal management operations.

### CROSS-REFERENCE TO RELATED APPLICATIONS

This application is related to U.S. patent application Ser. No. 11/590,755, which issued as U.S. Pat. No. 7,506,001 on Mar. 17, 2009, U.S. patent application Ser. No. 12/366,255, filed Feb. 5, 2009, which issued as U.S. Pat. No. 7,996,441 on Aug. 9, 2011, and U.S. patent application Ser. No. 13/164,395, filed Jun. 20, 2011, the contents of which are hereby incorporated by reference in their entirety. In addition, this application is related to U.S. patent application Ser. No. ______, entitled “System and Method for Managing a Proposal Lifecycle,” filed on an even date herewith, the contents of which are hereby further incorporated by reference in their entirety

### FIELD OF THE INVENTION

The invention generally relates to an enterprise proposal management system integrated with various enterprise systems, applications, data sources, and other resources to provide a comprehensive solution to manage and coordinate a proposal lifecycle and data associated therewith, and in particular to integrating and using business information stored in various different data sources to execute repeatable and effective strategies to create and manage business development and proposal efforts, reduce the time that proposal authors spend to search, retrieve, and use content from past proposals to create, write, and present proposals more likely to win new business, coordinate collaboration across organizational teams involved in proposal management, reliably track capture and proposal pipelines, and preserve documents, data, and other critical corporate information relevant to the proposal lifecycle, thereby providing real business value in day-to-day proposal management operations.

### BACKGROUND OF THE INVENTION

Enterprises and other organizations often have diverse business needs, with one of the most important aspects in enterprise management often relating to sales and business development processes. This complex practice typically includes many tangible and intangible variables, which tend to range from ensuring that transactions are competitively initiated to effectively delivering on promises. Properly managing these and other variables to develop effective business development practices can often be disjointed, for example, because employees, consultants, partners, customers, and others involved in business development pipeline management need access to specific data that tends to be stored in disparate departments and information silos when responding to a product or service solicitation, generally referred to as a “Request For Proposals.” In particular, when a potential customer solicits products, services, or other work via Requests For Proposals, Requests For Information, or Requests For Quote, the potential customer may request substantial information, including details relating to performance associated with similar or related work that an enterprise performed in the past, information relating to accounts, contracts, price quotes, and other financial data associated with the enterprise, corporate profiles, biographies, qualifications, and other capabilities that relate to whether the enterprise can deliver what the potential customer has requested, recommendations from third parties and relationships with partners that may work collaboratively with the enterprise, and technical specifications, estimated timelines, and proposed solution designs, among many other things.

As such, managing a proposal lifecycle requires an enterprise to have a handle on substantial and diverse resources in order to properly leverage and communicate the “reach” that the enterprise may have. For example, effectively managing a proposal lifecycle typically entails tracking and capturing leads that represent potential business opportunities, forming strategies to develop effective proposal solutions, researching potential customers, partners, competitors, and lessons from business opportunities pursued in the past, planning financial and human resource expenditures and schedules, assembling packaged proposals, and conducting post-process reviews to learn further lesions that may be applied to future business opportunities. Moreover, even after a particular proposal has been won or lost, the enterprise may continue to have significant information management needs, which may include negotiating and creating contracts relating to a proposal that was awarded and produced a business win, deploying human and financial resources to fulfill or otherwise deliver on the contract, interacting with vendors, partners, sub-contractors, or other third parties, developing timelines and milestones to track and ensure timely delivery, and conducting internal and external reviews to learn lessons relating to why the particular proposal was won or lost.

However, a typical enterprise may find themselves caught in swirling waters because the data needed to manage these and other phases in the proposal lifecycle tends to be stored in separate departments and information silos, which can substantially interfere with efforts to manage all materials and information necessary to manage the full proposal lifecycle and present such materials and information in a useful, intuitive, and informative way. In other words, existing enterprise management systems tend to take a divide-and-conquer approach, with separate systems and data stores to manage efforts to track and develop business leads, proposals, contracts, financial resources, human resources, schedules, resumes, and day-to-day tasks, which can cause unnecessary redundancy and data saturation with critical data scattered throughout the organization. Moreover, existing systems that attempt to integrate disparate repositories (e.g., via a data warehouse) nonetheless tend to be unable to integrate all organizational repositories and, information sources, particularly those that reside on individual machines. As such, the shortfalls associated with having distinct systems and data stores to manage all phases in a proposal lifecycle often creates competitive obstacles (e.g., because competitor information may be stored in private repositories, data relating to lost proposals or lost bids cannot be effectively analyzed, proposal authors may have to spend considerable time searching and retrieving content from past proposals or bids that were successful, collaboration to make proposal across different human resource teams may be difficult, and mechanisms to track capture and proposal pipelines may be unreliable, etc.).

Accordingly, without a unified solution to manage data relating to all phases in a proposal lifecycle, an enterprise may be unable or have difficulty searching all documents and other materials that have descriptive information that may provide advantages to building new business opportunities and expanding existing relationships to leverage business endeavors that already exist. Instead, the enterprise must typically rely on manual processes that require substantial time and resource expenditures, which may interfere' with efforts to consistently update documents, control informational lifespans, or otherwise manage how data relating to the proposal lifecycle will be used. These problems may even lead to the enterprise losing new business opportunities (or existing business) to competitors because inaccurate, incomplete, or outdated documents, financial data, personnel data, or other information may prevent the enterprise from suitably responding to all requirements in a Request For Proposals, correlate such requirements with products and, services that the enterprise offers, or result in negative evaluations due to missing communication links between different systems and data sources.

Further, without suitably integrating communication across disparate systems and data sources, a disconnect may arise between priorities assigned to different opportunities, how the opportunities fit business goals associated with the enterprise, and the need to share information about the different opportunities among different personnel teams and partners associated with the enterprise. As such, the enterprise may suffer from an imbalance in how resources are allocated to different opportunities, where opportunities that have low impacts or potential strategic value may receive substantial attention while opportunities with high impacts or potential strategic value languish. Moreover, the typical opaqueness across internal and external boundaries associated with an enterprise can prevent or otherwise interfere with fully exploiting the benefits that collaboration promise. In particular, without simple and integrated mechanisms to share key performance indicators and metrics, different personnel teams cannot successfully rally and work collaboratively to meet mutual goals. Further still, information disconnects can introduce substantial maintenance and troubleshooting overhead, particularly if distinct suppliers, vendors, or other third parties are needed to utilize or maintain information. As such, existing systems tend to fall short in providing seamless integration, communication, and interaction across all phases associated with a proposal lifecycle, which can substantially hinder efforts to track, develop, and leverage intelligent business strategies.

### SUMMARY OF THE INVENTION

According to one aspect of the invention, the system and method described herein may provide an integrated solution to manage various phases associated with a proposal lifecycle, wherein the system and method described herein may integrate business information and proposal knowledge stored in various data sources and provide tools to execute repeatable and effective strategies that relate to managing business development and proposal efforts within an enterprise. For example, the tools provided via the system and method described herein may reduce the time that proposal authors spend to search and retrieve content from past proposals (whether successful or unsuccessful), coordinate collaboration across teams involved in making proposals, reliably track capture and proposal pipelines, and preserve past proposals and other critical corporate information that may have relevance to managing proposal lifecycles. As such, the system and method described herein may provide capture management teams, proposal teams, contract teams, and other organizational teams with visibility into relevant proposal information that may exist throughout the enterprise and thereby improve work and life quality. For example, the system and method described herein may enable the organizational teams to gather, assemble, or otherwise manage Request For Proposals (RFP), Request For Information. (RFI), Request For Quote (RFQ), or Indefinite Delivery Indefinite Quantity (IDIQ) content, create, write, and present business and technical proposals more likely to win new business, and remove collaboration obstacles to provide real business value in day-to-day proposal management operations. Accordingly, the system and method described herein may provide an integrated approach to manage the proposal lifecycle, which may include phases to create a Request For Proposals, assess whether an enterprise should pursue a certain Request For Proposals opportunity, develop a strategy to draft a winning proposal should the enterprise pursue the opportunity, manage collaboration among disparate personnel teams to develop the proposal, manage a contract to deliver on the proposal if the enterprise wins the opportunity, review lessons learned associated with the opportunity to build intelligence that can support efforts relating to subsequent opportunities or proposal efforts (whether the enterprise wins or loses the opportunity), and manage documents, data, and other information that can provide high-quality reference materials that may be used to support the efforts relating to the subsequent opportunities or proposal efforts.

According to one aspect of the invention, the system and method described herein may provide business development, sales, and proposal management personnel with user-friendly views relating to sales and proposal pipelines, simplify access to critical proposal-related information and data, share proposal-related documents, information, and other data through Request For Proposals, business development, opportunity capture, proposal development, and post-submission phases associated with the proposal lifecycle. For example, the system and method described herein may be used to create, manage, and otherwise control proposal templates, letters, models, and outlines, provide virtual proposal workspaces where virtual proposal teams can effectively and securely collaborate across functions, units, organizations, and locations, and organize proposal related documents, information, and other data in logical and searchable data structures. Furthermore, the system and method described herein may include safeguards to protect the confidentiality associated with proprietary information within and across various organizational tiers, use task assignments, activity calendars, and advanced search features to support collaborative communication within and across organizational teams and sub-teams, and manage workflow processes to coordinate interaction among teams and sub-teams within the enterprise and partners associated with the enterprise. As such, the system and method described herein may enable various personnel and partner teams to successfully collaborate in efforts to develop and respond to business opportunities, coordinate human and financial resources across the enterprise to develop proposal and contract documents, ensure accountability associated with proposal and contract submissions, reviews, and oral presentations, collect information relating to needs assessments, customer requirements, risk management, technical capabilities, and financial resources to oversee the full proposal lifecycle, and manage questions, proposal responses, oral augmentations, and presentations associated with every phase associated with the proposal lifecycle.

According to one aspect of the invention, the system and method described herein may include an integrated solution to manage the proposal lifecycle, wherein the integrated solution may generally include modules to support a Request For Proposals (RFP) phase, a business development phase, an opportunity capture phase, a proposal development phase, and a post-submission phase associated with the proposal lifecycle. In particular, the Request For Proposals module may generally gather and assemble Request For Proposals, Request For Information, Request For Quote, and Indefinite Delivery Indefinite Quantity content from various data sources, which may be used to populate a data repository with documents, data, and other information that can be referenced to create a Request For Proposals, a Request For Information, a Request For Quote, or an Indefinite Delivery Indefinite Quantity listing that can be submitted into a suitable marketplace. For example, in one implementation, the system and method described herein may search the RFP Database (RFPdb) marketplace or other suitable data sources that publish project listings released from third parties to identify government, corporate, non-profit, Request For Proposals, or other work solicitation listings. As such, in addition to the modules that support the business development, opportunity capture, proposal development, and post-submission phases, which may be used to assess and respond to a Request For Proposals or other business opportunity that a third party may submit, the Request For Proposals module may support an initial proposal lifecycle phase, in which a Request For Proposals, Request For Information, Request For Quote, or Indefinite Delivery Indefinite Quantity listing may be created to solicit work from other parties.

According to one aspect of the invention, the module to support the business development phase in the proposal lifecycle may be used to track leads, manage campaigns, review internal policies, processes, and strategies, and analyze intelligence relating to partner capabilities, competitor capabilities, and past, present, or anticipated proposals to determine whether or not a particular business opportunity should be pursued. In particular, the business development module may integrate information associated with tasks, documents, deliverables, and other data from various sources within an enterprise to build proposal intelligence that can be leveraged to develop competitive strategies and evaluate opportunities or proposal solicitations. In one implementation, the business development module may therefore produce information that relates to strategic planning, pursuit strategies, sales disciplines and support capabilities, market and competitor activities, target prospects, and financial account plans to inform decision-making relating to whether or not certain opportunities or proposal solicitations should be pursued. In one implementation, the information produced therewith may be persistently stored to update proposal intelligence that can be analyzed and referenced to review the processes that led to the decision about whether or not to pursue the opportunities or proposal solicitations. For example, the system and method described herein may be integrated with a customer relationship management system having marketing materials or other information relevant to competitive analysis, which may be referenced and updated to include information that describes a relative competitive position associated with the enterprise, a likelihood that the enterprise will win the proposal (if pursued), or other business development intelligence. Furthermore, the system and method described herein may be integrated with a personnel management system that, includes human resource resumes, profiles, or other materials that can be used to identify subject matter experts, qualified personnel, enterprise capabilities, or other information that can differentiate the enterprise from possible competitors. Accordingly, the business development module may be integrated with various enterprise data resources that have information relevant to the decision-making needed to assess potential business leads, differentiate potential competitors, prioritize the potential leads according to how the leads fit the business model associated with the enterprise, or otherwise decide whether or not to initiate proposal development efforts.

According to one aspect of the invention, the module to support the opportunity capture phase in the proposal lifecycle may be invoked in response to the enterprise using the business development module to make a decision that a particular Request For Proposals or other business opportunity should be pursued. In particular, the opportunity capture module may generally support forming, training, or otherwise planning capture teams that include human resources or other personnel that will collaboratively perform various tasks to develop strategies to capture the potential business opportunity. To that end, the opportunity capture module may manage one or more workflows to coordinate interaction among the personnel in the capture team, wherein the workflows may manage various tasks to prepare and implement an initial plan to capture the potential business opportunity. For example, the workflows may coordinate interaction that relates to analyzing intelligence associated with the potential customer (i.e., a third party that submitted the Request For Proposals or other solicitation) and forming a strategy to develop a relationship with the potential customer (e.g., expanding any existing relationships that the enterprise has with the potential customer, reaching out to the potential customer to initiate a relationship, etc.). Furthermore, in one implementation, the workflows may coordinate interaction in which the capture teams makes key assessments that relate to the Request For Proposals or other solicitation, which may include ranking different factors, programs, requirements, or other information that relates to the opportunity. As such, the capture team may then review the key assessments to develop and implement strategies to respond to the opportunity in a manner that may differentiate the enterprise from potential competitors and produce a price estimate likely to result in a business win (e.g., identifying capabilities associated with the enterprise that certain competitors may lack, estimating a price that the competitors are likely to submit to produce a more competitive price estimate, etc.). Accordingly, the opportunity capture module may be integrated with various enterprise data resources that have information relevant to the decision-making needed to capture the potential business lead and make a preliminary decision relating to a bid amount to submit in response to the potential lead and maximize a likelihood a business win will be produced.

According to one aspect of the invention, the module to support the proposal development phase in the proposal lifecycle may be invoked in response to the enterprise using the opportunity capture module to make the preliminary decision relating to the bid amount to submit in response to the potential lead. In particular, the proposal development module may generally leverage the documents, data, and other information in the various integrated data sources to provide high-quality reference materials that may be used to support efforts to develop a proposal document and manage tasks associated therewith. In one implementation, the proposal development module may draw upon enterprise-wide resources to validate the baseline strategy and preliminary bid decision made with the opportunity capture module to develop a proposal strategy likely to win the business opportunity. For example, the proposal development module may collate information relating to marketing, human resources, past proposals and contracts, resource planning, operations, procurement, finance, and other enterprise areas to prepare a proposal that best responds to requirements or other needs that the potential customer specified in the Request For Proposals or other work solicitation. As such, in one implementation, the proposal development module may generally support the efforts to develop the proposal document and manage tasks associated therewith in multiple phases, which may generally include proposal planning and proposal preparation phases.

According to one aspect of the invention, the proposal planning phase managed with the proposal development module may generally be used to initially form, train, or otherwise plan proposal teams that include human resources or other personnel that will collaboratively perform various tasks to validate and plan strategies to prepare the proposal. To that end, the proposal development module may manage one or more workflows to coordinate interaction among the personnel in the proposal teams, wherein the workflows may manage various tasks to review lessons learned from business opportunities that were pursued in the past, proposals that were prepared and submitted in response to the business opportunities pursued in the past, and outcomes associated therewith (e.g., whether the proposals resulted in business wins or losses, factors that led to the proposals resulting in business wins or losses, etc.). As such, the proposal teams may collaboratively review the lessons learned via the workflows to assess the baseline solution and pricing strategy made with the opportunity capture module, wherein the baseline solution and pricing strategy may be extended into a proposal strategy in response to the proposal team validating the baseline solution and pricing strategy. In response thereto, the proposal development module may review the Request For Proposals or other materials that the potential customer provided in relation to the opportunity to extract requirements, requests, or other criteria associated with the opportunity and create a compliance matrix or requirements matrix that may be used to ensure that the proposal will address all requirements, requests, or other criteria that the potential customer provided. For example, the proposal development module may identify certain keywords in the opportunity materials that reflect potential requirements (e.g., “will,” “shall,” “must,” etc.) and context around those keywords may be pulled from the opportunity materials to create the compliance matrix. In response to creating the compliance matrix, to complete the proposal planning phase, the proposal development module may prepare writer packages to specify documents, data, or other information that the proposal will need to address all issues identified in the compliance matrix and create a draft executive summary to outline the baseline solution and proposal plan. The workflows may then schedule a kickoff meeting in which the proposal teams will collaboratively review and/or revise the proposal plan, validate and/or revise the preliminary bid decision, and initiate the proposal preparation phase.

According to one aspect of the invention, in response to the proposal teams collaboratively reviewing the proposal plan and validating the preliminary bid decision, the proposal preparation phase may be initiated to prepare the proposal document to submit in response to the Request For Proposals or other business opportunity. In particular, the proposal preparation phase may generally have the workflows coordinate interaction among the proposal teams to plan responses to all the issues identified in the compliance matrix, initiate detailed cost estimates relating to the baseline solution or offering described in the proposal plan, update the draft executive summary if appropriate, wherein the baseline solution or offering described in the proposal plan may then be frozen prior to subsequent efforts to develop the proposal document. In one implementation, the proposal development module may then execute one or more workflows to coordinate various tasks in which the personnel on the proposal teams may retrieve documents, data, or other information from the various integrated data sources (e.g., documents or materials from past proposals that were successful and suitably related to the present opportunity and therefore provide high-quality reference materials to prepare the present proposal document), wherein the personnel on the proposal teams may use the retrieved documents, data, or other information to assemble and revise text associated with the present proposal document. In response to the proposal teams approving the revised text associated with the proposal document, materials that make up the proposal document may be merged and custom cover pages, fonts, and other formatting may be combined therewith to create the final proposal document and submit the final proposal document in response to the Request For Proposals or other business opportunity.

According to one aspect of the invention, the proposal development module may therefore manage various workflows, tasks, documents, data, and other information to support the proposal planning and proposal preparation phases, which may ensure that the enterprise can suitably respond to the requirements, requests, needs, or other criteria that the potential customer specified. In particular, to support the proposal planning and proposal preparation phases, the proposal development module may evaluate submission deadlines, bid or no-bid issues, bid schedules, the compliance matrix, or other issues that relate to preparing the final proposal document to oversee and implement the proposal strategy developed to win the opportunity. For example, the proposal development module may manage various workflows that assign resources, documents, tasks, deliverables, or other proposal materials to personnel on the proposal teams and provide status updates to the personnel on the proposal teams to coordinate collaboration schedules and planning meetings that relate to planning and preparing the proposal within the enterprise. In addition, to oversee and implement the proposal strategy, the proposal development module may decide what needs to be written and when, develop outlines, storyboards, and checklists, organize reviews and submissions, or manage any other tasks to ensure that the proposal document will have timely, comprehensive, and competitive responses. The proposal development module may further assimilate new materials with best practices, graphics, boilerplate language, reviews, and other existing materials to simplify the processes in which the proposal teams will draft the production proposal and coordinate workflows to validate the production proposal against the compliance matrix and thereby provide a built-in mechanism to correct, amend, and identify errors or missing elements, clarify and change requirements associated with the opportunity, and provide status reports to ensure consistent collaboration and teamwork.

According to one aspect of the invention, the module to support the post-submission phase in the proposal lifecycle may be invoked in response to the proposal development module having been used to validate the proposal strategy and pricing decision and submit the production proposal or otherwise finalized proposal document in response to the business opportunity. In particular, the post-submission module may generally further leverage the various document, data, and other information in the integrated data sources to archive any materials created, revised, referenced, or otherwise used in the business development, opportunity capture, and proposal development phases and update the integrated data sources to closeout the strategies and plans used therein, thereby updating the proposal intelligence that may be used to manage any phase in subsequent proposal lifecycles. Further, the post-submission module may manage one or more workflows to coordinate collaboration among personnel having responsibility to respond to questions that the potential customer may have in relation to the proposal submitted in response to the opportunity and conduct an oral presentation associated with the submitted proposal to the potential customer. In one implementation, in response to the potential customer rejecting the submitted proposal or requesting revisions or further information relating to the proposal, the workflows may invoke the proposal development module to update and resubmit the proposal if appropriate. Alternatively (or additionally), the workflows managed via the post-submission module may coordinate contract negotiations between the enterprise and the potential customer if the potential customer accepts the proposal and awards the contract to the enterprise. Moreover, the workflows may manage various tasks within the enterprise to coordinate schedules, milestones, or other issues to ensure proper delivery on the contract and subsequent tasks that relate to a debriefing with the customer once the contract has been delivered or otherwise completed. In one implementation, the post-submission module may then review various documents, data, and other information used therein to conduct lessons learned and appropriately update the proposal intelligence that may be used to manage subsequent proposal lifecycles. Accordingly, the post-submission module may generally coordinate and perform post-process review on various tasks, schedules, and other resources relating to the proposal and any contract awarded thereon and proposals or other materials that competitors submitted in response to the opportunity, which may be referenced to differentiate approaches relating to the proposals and solutions that the enterprise and the competitors developed and factors that impacted whether the proposals and solutions winning or losing the opportunity. As such, information describing the differentiations between the approaches and the impacting factors may be collected and analyzed to update and enhance the proposal intelligence that may be used to manage or otherwise inform subsequent proposal lifecycles.

According to one aspect of the invention, the architecture used in the system and method described herein may further include a third party interface to support communication, interaction, or other collaboration among the enterprise and partners or vendors that work with the enterprise. For example, if the enterprise will be a prime contractor delivering the solution described in the proposal, the enterprise may use the third party interface to request related services from the partners, vendors, or other third parties that may potentially become sub-contractors assisting with delivering the solution, verify that the partners, vendors, or other third parties have capabilities to meet the needs that would be required from potential sub-contractors, and provide analytics relating to the capabilities associated with the partners, vendors, or other third parties (e.g., average times to respond, whether the third parties have actually met the needs that would be required from potential sub-contractors in prior business cases, performance reports from other entities, etc.). Similarly, if the enterprise will be a sub-contractor, the enterprise may receive related service requests from the prime contractor via the third party interface and send responses or other services to the prime contractor via the third party interface. In one implementation, if the potential customer accepts the proposal and awards the contract to the enterprise (and therefore becomes an actual customer), the customer may use the third party interface to request or retrieve reports, relating to the performance under the contract via self-service. Moreover, the third party interface may provide access points that the customer, prime contractor, and any sub-contractors can use to interact, interface, or otherwise collaborate to coordinate and manage contract performance.

According to one aspect of the invention, the architecture used in the system and method described herein may generally have a modular framework that allows the various modules, interfaces, and other components described above to be shipped in the same product to any suitable entity that may desire to use certain modules, interfaces, or other components associated therewith. As such, the product shipped to any particular entity may enable the particular modules, interfaces, or other components that the entity desires to use and any other modules, interfaces, or other components may be disabled. For example, the product shipped to an entity planning to use the architecture to generate Request For Proposals content may have the Request For Proposals module and third party interface enabled, while the business development, opportunity capture, proposal development, and post-submission modules may be disabled. However, because the shipped product includes all the modules, interfaces, and other components associated with the architecture, the business development, opportunity capture, proposal development, and post-submission modules may simply be enabled should the entity later desire to use the architecture to respond to work solicitations or other business opportunities that third parties submit rather than needing to have a new product shipped and integrated with the previously enabled features. In one implementation, the modular framework may further include a promote lifecycle feature that controls whether a particular business opportunity can be promoted from a current phase in the lifecycle to a next phase in the lifecycle. In particular, the promote lifecycle feature may define required documents, required tasks, and any other custom requirements that must be completed before the business opportunity can be promoted from the current phase to the next phase and thereby control how the proposal lifecycle progresses (e.g., requiring documents to support the analysis underlying a pursuit recommendation before the opportunity can be promoted from the business development phase to the opportunity capture phase). In one implementation, the architecture may further include analytic tools that can leverage the documents, data, or other information generated or used throughout the proposal lifecycle to manage other business activities within the enterprise (e.g., customer, competitor, and partner intelligence may be used to analyze conflicts of interest, business development trends that show how the architecture may be adding value or producing real-world business wins, etc.).

According to one aspect of the invention, the system and method described herein may include various document creation tools to simplify and streamline the processes that the enterprise follows to create proposal documents, contract documents, or any other document that may be produced during the proposal lifecycle. For example, the document creation tools may include a shredder/requirements finder that can search a Request For Proposals or other materials relating to a business opportunity to identify certain keywords that represent potential requirements, wherein the shredder/requirements finder may then pull any sentences, paragraphs, or other textual context that contain the identified keywords from the Request For Proposals or other materials to create a compliance matrix. As such, the compliance matrix may be referenced during the proposal development or post-submission phases to ensure that all requirements associated, with the business opportunity have been addressed. In addition, the shredder/requirements finder may be used to mitigate risk, wherein certain words that may introduce risk to the enterprise may be located and replaced across various documents that will be used in the final proposal or contract document (e.g., changing the phrase “shall provide” to “may provide,” the phrase “must perform” to “will endeavor to perform,” etc.). Furthermore, the document creation tools may include an obtain content feature, which may provide a drag-and-drop interface where business development libraries, best-in-class libraries, prior opportunity libraries, or other suitable libraries may be searched to identify boilerplate documents, materials from prior proposals or contracts, or any other data to use in creating the proposal or contract documents. In one implementation, certain documents identified in the libraries may then be selected and placed into a target workspace that preserves a consistent data location associated with the document under development, or the obtain content feature may be suitably used to deliver or otherwise manage the documents outside a workspace.

According to one aspect of the invention, the various document creation tools provided in the system and method described herein may further include a document merge feature that can save substantial time and substantially simplify potentially cumbersome processes otherwise used to develop proposal and contract documents. In particular, in response to personnel on one or more teams having responsibility to create a particular document using the obtain content feature to select the boilerplate documents, materials from prior proposals and contracts, and other data to use in creating the current document, the document merge feature may perform one or more mass changes to tailor the selected documents, materials, and other data to the current business opportunity. For example, all occurrences naming a previous customer or other entity across all the selected documents, materials, and other data selected from the libraries may be automatically replaced with the name associated with the potential customer on the current opportunity, certain words or phrases may be replaced to mitigate risk in the manner noted above, certain character codes may, be deleted to provide consistent formatting (e.g., removing all “̂m” characters to delete page breaks), or any other suitable change may be applied across all selected documents, materials, and other data to perform mass changes tailored to the current business opportunity. In one implementation, all mass changes that were made may be tracked and pulled from the appropriate documents, materials, or other data to show context around the changes to enable appropriate teams to review and approve or reject the changes. In response to all selected documents, materials, and other data having been added to the workspace or other document management location, appropriately modified and tailored to the current opportunity, and all changes appropriately reviewed, the document merge feature may be executed to assemble the overall document, add custom cover pages, fonts, and other formatting, and send the final document to appropriate destinations (e.g., the libraries, internal or external recipients, etc.). Furthermore, the document merge feature can run at scheduled times, manually, in response to certain events or conditions (e.g., once a team member has completed a particular task associated with developing the document). The final document may then be reviewed and all changes and comments thereto may be rolled up to create a summary that describes how the document was created and tailored to the current opportunity.

Other objects and advantages of the invention will be apparent to those skilled in the art based on the following detailed description and the accompanying drawings.

### BRIEF DESCRIPTION OF THE DRAWINGS

FIG. 1 illustrates an exemplary modular architecture that may be used to manage and coordinate a proposal lifecycle, according to one, aspect of the invention.

FIG. 2 illustrates an exemplary service oriented architecture that may implement an enterprise proposal management system to manage and coordinate a proposal lifecycle, according to one aspect of the invention.

FIG. 3A illustrates an exemplary enterprise ready environment that may include a scalable sandbox and production environment to manage and coordinate a proposal lifecycle, while FIG. 3B illustrates an exemplary hybrid Software-as-a-Service environment that may be used to manage and coordinate a proposal lifecycle, according to one aspect of the invention.

### DETAILED DESCRIPTION

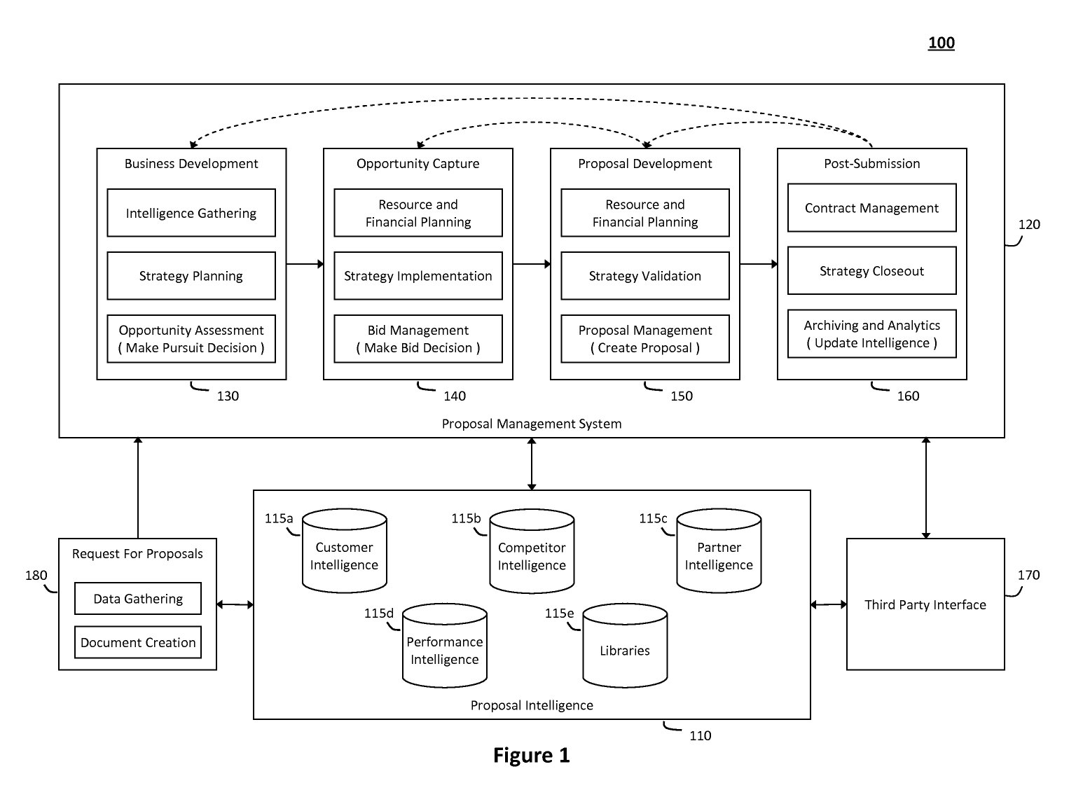

According to one aspect of the invention, FIG. 1 illustrates an exemplary modular architecture 100 that may be used to manage and coordinate a proposal lifecycle and provide an integrated solution to manage various phases associated with a proposal lifecycle. In particular, the modular architecture 100 shown in FIG. 1 may integrate business information and proposal knowledge stored in various data sources to build proposal intelligence 110 that can be referenced or otherwise used to execute repeatable and effective strategies that relate to managing business development and proposal efforts within an enterprise. For example, the architecture 100 may integrate a proposal management. system 120 with the proposal intelligence 110, wherein the proposal management system 120 may have various tools that can substantially reduce the time that proposal authors spend to search and retrieve content from past proposals (whether successful or unsuccessful), coordinate collaboration across teams that may be involved in making proposals, reliably track capture and proposal pipelines, and preserve past proposals and other critical corporate information that may have relevance to managing proposal lifecycles. As such, in one implementation, the modular architecture 100 may provide personnel on capture management teams, proposal teams, contract teams, and other organizational teams with visibility into relevant proposal intelligence 110 that may exist throughout the enterprise and thereby improve work and life quality. For example, the architecture 100 may enable the organizational teams to gather, assemble, or otherwise manage Request For Proposals (RFP), Request For Information (RFI), Request For Quote (RFQ), or Indefinite Delivery Indefinite Quantity (IDIQ) content, create, write, and present business and technical proposals more likely to win new business, and remove collaboration obstacles to provide real business value in day-to-day proposal management operations.

In one implementation, the architecture 100 shown in FIG. 1 may therefore provide an integrated approach to manage the proposal lifecycle, which may include a Request For Proposals phase to create materials that can be used to solicit products, services, or other work from third parties, a business development phase to assess whether the enterprise should pursue a certain Request For Proposals or other work solicitation that represents a potential business opportunity, an opportunity capture phase to develop a winning proposal strategy should the enterprise pursue the potential business opportunity, a proposal development phase to manage collaboration among personnel teams involved in developing the proposal according to the winning proposal strategy, and a post-submission phase to manage a contract to deliver a solution described in the proposal if the enterprise wins the opportunity. Furthermore, in one implementation, the post-submission phase in the proposal lifecycle may include learning lessons from the opportunity to build the proposal intelligence 110 and manage documents and other data that can provide high-quality reference materials to support managing current and future business opportunities or proposal efforts. As such, the architecture 100 may provide business development, sales, and proposal management personnel with user-friendly views relating to sales and proposal pipelines via simplified and shared access to critical proposal-related documents, data, and other proposal intelligence 110 throughout the Request For Proposals, business development, opportunity capture, proposal development, and post-submission phases.

For example, as will be described in further detail herein, the architecture 100 may be used to create, manage, and otherwise control proposal templates, letters, models, and outlines, provide virtual proposal workspaces where virtual proposal teams can effectively and securely collaborate across functions, units, organizations, and locations, and organize proposal related documents, information, and other data in logical and searchable data structures. Furthermore, the architecture 100 may include safeguards to protect confidentiality associated with proprietary information contained in the proposal intelligence 110 within and across various organizational tiers, combine task assignments, activity calendars, timesheets, and other personnel data with advanced search features to support collaborative communication within and across organizational teams and sub-teams, and manage workflow processes to coordinate interaction among teams and sub-teams that include personnel within the enterprise and partners associated therewith. As such, the modular architecture 100 may enable various personnel and partner teams to successfully collaborate in efforts to develop and respond to potential business opportunities, coordinate human and financial resources within and across enterprise boundaries to develop proposal and contract documents, ensure accountability associated with submissions, reviews, and oral presentations that relate to proposals and contracts, collate needs assessments, customer requirements, risk management data, technical capabilities, and financial resources to oversee every phase in the full proposal lifecycle, and manage questions, proposal responses, oral augmentations, and presentations associated with every phase in the full proposal lifecycle.

In one implementation, the proposal intelligence 110 may generally include customer intelligence 115a, competitor intelligence 115b, partner intelligence 115c, performance intelligence 115d, and one or more libraries 115e, which may collectively provide institutional knowledge that can be referenced or otherwise used to manage any suitable phase in the proposal lifecycle. Accordingly, as will be described in further detail herein, the documents, data, and other information captured in the proposal intelligence 110 may be used to develop competitive business strategies, prioritize business pursuits according to potential value or other objectives associated with the enterprise, make competitive bids that have a strong likelihood to beat competitor bids and reflect a financial status associated with the enterprise, create competitive and well-informed proposals that differentiate competitor capabilities and meet the requirements or other needs associated with potential customers, and leverage lessons learned from internal and external factors associated with past, present, and anticipated business opportunities to learn the reasons why particular business opportunities are won or lost and thereby improve the likelihood that the enterprise will satisfy ongoing and future business development needs and win new business.

In particular, in one implementation, the customer intelligence 115a may be integrated with a customer relationship management system or other suitable data sources having sales, marketing, customer service, technical support, and other materials relevant to competitive analysis and interaction with actual and potential clients, prospects, or other customers, which may be derived from knowledge relating to existing relationships, in-process and post-submission review relating to existing, new, or potential relationships, public relations materials, independent research via Freedom of Information Act requests, or any other suitable reference source that can provide knowledge to build profiles relating to actual and potential customers. For example, in one implementation, the customer intelligence 115a may include, among other things, acronyms, definitions, dictionaries, or other terminology unique to specific organizations or other entities that represent the actual or potential customers, requirements, needs, or other goals that the actual or potential customers have in relation to conducting business within certain industries, personnel or contacts that released the Request For Proposals or other work solicitation, and any preferences that the actual or potential customers have specified or exhibited in relation to a previous or current Request For Proposals or other work solicitation (e.g., emphasizing timely delivery over reducing cost, incumbent preferences reflecting tendencies to award contracts to certain organizations, etc.). Accordingly, the customer intelligence 115a may be derived from various sources to build knowledge or other customer profiles that can be referenced to assess a relative competitive position that the enterprise may have in relation to a particular opportunity, a likelihood that the enterprise will win the opportunity, perform customer outreach to communicate enterprise qualifications or capabilities, identify key differentiators to increase the competitiveness associated with proposal or bid submissions, or otherwise inform business development goals to maintain existing business opportunities and win new business opportunities.

In one implementation, the competitor intelligence 115b may be further integrated with the customer relationship management system or other suitable data sources used to build the knowledge in the customer intelligence 115a in order to build profiles relating to actual or potential competitors. For example, in one implementation, the competitor intelligence 115b may include, among other things, capabilities or subject matter expertise that the actual or potential competitors may have generally or in relation to particular business opportunities, activities or trends associated with the actual or potential competitors, activities or trends in industries or markets associated with the actual or potential competitors or particular business opportunities, biographical or financial information associated with the competitors, any relationships that the competitors may have with certain customers, vendors, or partners and histories associated therewith (e.g., whether customers have expressed dissatisfaction with certain competitors). Furthermore, in one implementation, the competitor intelligence 115b may deconstruct opportunities that the competitors pursued in the past (whether won or lost, and whether or not the enterprise was involved therewith) to profile the factors that resulted in the competitors winning or losing the opportunities, which may learned via Freedom of Information Act requests or other suitable techniques. As such, the deconstructed opportunities may provide knowledge relating to prices that the competitors have previously charged or are likely to bid in relation to certain business opportunities, proposals or other materials that the competitors submitted in response to the opportunities, and whether or not the previously charged prices and material submissions resulted in the competitors winning or losing the business opportunities. As such, the competitor intelligence 115b may provide competitor profiles that inform decisions about whether or not to pursue certain opportunities, differentiate actual and potential competitors if certain opportunities are pursued, and improve the likelihood that the enterprise will win opportunities that are pursued.

In one implementation, the partner intelligence 115c may be further integrated with the data sources used to build the knowledge in the customer intelligence 115a and the competitor intelligence 115b that profiles actual or potential customers and competitors. More particularly, the partner intelligence 115c may include knowledge relating to organizations or other entities that have previously worked with the enterprise in a vendor, outsourcing, or other support capacity or may have capabilities or subject matter expertise that make the organizations or other entities candidates to work with the enterprise on current or future opportunities. For example, in one implementation, the partner intelligence 115c may include, among other things, capabilities, subject matter expertise, strengths, and weaknesses that actual or potential partners may have generally or in relation to particular business opportunities, activities or trends associated with the actual or potential partners or industries or markets that relate to the actual or potential partners, biographical or financial information associated with the partners, any relationships that the partners may have that can be leveraged in relation to a particular opportunity, evaluations that the enterprise or third parties have provided with respect to work that the actual or potential partners previously performed. As such, the partner intelligence 115c may profile actual or potential vendors, sub-contractors, or other partners to inform current and future business development efforts, identify organizations that have successful or unsuccessful past working experience, and draw knowledge from previous working relationships to minimize risk and create winning proposals (e.g., if a particular vendor organization has historically fallen short in fulfilling obligations, the enterprise may hire a different vendor to ensure that the obligations will be fulfilled).

In one implementation, the performance intelligence 115d may include documents, materials, data, and other information relating to business opportunities that the enterprise has considered and pursued in the past in addition to personnel, finances, capabilities, and other information relating to how the enterprise performed in relation to the opportunities that were considered and pursued in the past. More particularly, the performance intelligence 115d may include information relating to the reasons why the enterprise chose to pursue or forego certain business opportunities, analysis relating to any reasons why the enterprise may have won or lost any opportunities that were pursued, and evaluations from customers and partners on contracts that were awarded to the enterprise on the opportunities that were pursued. In addition, the performance intelligence 115d may include resumes, performance evaluations, biographies, subject matter experts, human resource expenditures, timelines, personnel teams, or any other suitable data relating to personnel that were involved in the opportunities previously considered and pursued. Furthermore, the performance intelligence 115d may include values associated with proposal bids, awarded contracts, return ratios, or any other suitable data relating to finances associated with the previously considered and pursued opportunities. For example, if a particular business unit within the enterprise previously expended 8000 hours submitting four proposals that resulted in two contracts, with one contract valued at $125,000.00 and the other valued at $430,000.00, the performance intelligence 115d may assign the business unit a $69.38 per hour return ratio that can be considered to determine whether or not to pursue a new business opportunity that would involve that business unit. As such, the performance intelligence 115d may provide knowledge to profile the considerations that the enterprise used to determine whether or not pursue certain opportunities and outcomes from opportunities that were pursued to inform subsequent business development efforts and improve the likelihood that opportunities pursued in the future will produce business wins.

In one implementation, the libraries 115e may include various documents and materials that may be referenced or otherwise used to manage any phase in the proposal lifecycle, wherein the documents and materials may relate to the knowledge captured in the customer intelligence 115a, competitor intelligence 115b, partner intelligence 115c, performance intelligence 115d, or any other documents or materials relevant to business development or management. For example, in one implementation, the libraries 115e may include documents or other materials relating to proposals that the enterprise submitted in response to opportunities that were pursued in the past, documents or other materials relating to contracts awarded to the enterprise on the pursued opportunities, resumes, evaluations, capabilities, and financial data relating to customers, competitors, partners, or the enterprise, best practice materials, strategic plans, intellectual property, boilerplate language, proposal and contract sections, abstracts, case studies, commendation letters, images, or any other information relevant to creating or managing proposals, contracts, and other enterprise documents. As such, the libraries 115e may generally collate and organize institutional knowledge and provide high-quality reference materials that can be referenced or used to coordinate analysis, strategic planning, collaboration, or any other suitable task associated with the proposal lifecycle.

In one implementation, the architecture 100 and method described herein may include various modules that can reference, use, or other interact with the proposal intelligence 110 provide the integrated solution to manage the proposal lifecycle. More particularly, as described in further detail herein, the various modules may include Request For Proposals module 180 to manage the Request For Proposals phase, a business development module 130 to manage the business development phase, an opportunity capture module 140 to manage the opportunity capture phase, a proposal development module 150 to manage the proposal development phase, and a post-submission module 160 to manage the post-submission phase.

In one implementation, as shown in FIG. 1, the Request For Proposals module 180 may generally include a data gathering engine that can gather, assemble, or otherwise capture Request For Proposals, Request For Information, Request For Quote, and Indefinite Delivery Indefinite Quantity content from various sources. For example, in one implementation, the data gathering engine may search the RFP Database (RFPdb) and other suitable marketplaces or data sources that publish project listings released from third parties to gather, assemble, or capture government, corporate, non-profit, Request For Proposals listings, and other work solicitations. In one implementation, the data gathering engine may then use content associated with the work solicitations gathered from the RFP Database and the other suitable marketplaces or data sources to populate the proposal intelligence 110. In particular, the work solicitations content used to populate the proposal intelligence 110 may include documents, data, materials, and other information that a document creation engine can reference or otherwise use to create a Request For Proposals, a Request For Information, a Request For Quote, an Indefinite Delivery Indefinite Quantity, or other suitable listing that can be published or released to solicit work from third parties. In one implementation, in response to the document creation engine associated with the Request For Proposals module 180 creating the listing, the Request For Proposals module 180 may then be used to submit the listing into a suitable marketplace to solicit work from third parties (e.g., the RFP Database). As such, in addition to the modules that support the business development, opportunity capture, proposal development, and post-submission phases, which may be used to assess and respond to a Request For Proposals or other business opportunity that a third party may submit, the Request For Proposals module 180 may support an initial phase in the proposal lifecycle phase, in which a Request For Proposals, Request For Information, Request For Quote, or Indefinite Delivery Indefinite Quantity listing may be created to solicit work from other parties.

In one implementation, the business development module 130 may be used to track leads, manage campaigns, review internal policies, processes, and strategies, and otherwise analyze the proposal intelligence 110 to assess capabilities associated with actual or potential competitors, partners, and past, present, or anticipated proposals to determine whether or not a particular business opportunity should be pursued. In particular, the business development module 180 may leverage information associated with various tasks, documents, deliverables, and other data captured in the proposal intelligence 110 to develop competitive strategies and evaluate whether or not to pursue certain opportunities or proposal solicitations. In one implementation, the business development module 130 may therefore produce information that relates to strategic planning, pursuit strategies, sales disciplines and support capabilities, market and competitor activities, target prospects, and financial account plans to inform determinations relating to whether or not certain opportunities should be pursued. In one implementation, the determinations produced with the business development 130 may be persistently stored to update the proposal intelligence 110, which can then be analyzed and referenced to subsequently review or audit the processes that led to the decision about whether or not to pursue certain opportunities. For example, in one implementation, the business development module 130 may reference marketing materials, customer profiles, competitor profiles, partner profiles, performance associated with previous proposals, or any other proposal intelligence 110 relevant to competitive analysis. As such, the business development module 130 may reference the proposal intelligence 110 to assess a relative competitive position that the enterprise may have in relation to a certain opportunity and a likelihood that the enterprise will win the opportunity to make the decision about whether or not the, opportunity should be pursued. Furthermore, in response to making the pursuit decision, the business development module 130 may update the proposal intelligence 110 to preserve a context that captures the decision-making processes that ultimately led to the decision. Accordingly, the business development module 130 may reference, use, and update the proposal intelligence 110 to capture information relevant to the decision-making needed to assess potential business leads, differentiate potential competitors, prioritize the potential leads according to how the leads fit the business model associated with the enterprise, or otherwise make decisions about whether or not to initiate proposal development efforts.

In one implementation, the opportunity capture module 140 may be invoked in response to the business development module 130 producing a decision that a certain Request For Proposals or other business opportunity should be pursued. In particular, the opportunity capture module 140 may generally support forming, training, or otherwise planning capture teams that include human resources or other personnel that will collaboratively perform various tasks to develop strategies to capture the potential business opportunity. To that end, the opportunity capture module 140 may manage one or more workflows to coordinate interaction among the personnel in the capture team, wherein the workflows may manage various tasks to prepare and implement an initial plan to capture the potential business opportunity. For example, the workflows may coordinate interaction that relates to analyzing information captured in the customer intelligence 115a that relates to the potential customer (i.e., a third party that submitted the Request For Proposals or otherwise originated the opportunity to be captured), and the workflows may further coordinate interaction that relates to forming a strategy to develop a relationship with the potential customer (e.g., expanding any existing relationships that the enterprise has with the potential customer, reaching out to the potential customer to initiate a relationship or communicate enterprise capabilities, etc.). Furthermore, in one implementation, the workflows may coordinate interaction in which the capture teams makes key assessments that relate to the Request For Proposals or other solicitation, which may include ranking different factors, programs, requirements, or other information that relates to the opportunity. As such, the capture team may then review the key assessments to develop and implement strategies to respond to the opportunity in a manner that may differentiate the enterprise from potential competitors and produce a price estimate likely to result in a business win (e.g., identifying capabilities associated with the enterprise that certain competitors may lack, estimating a price that the competitors are likely to submit to produce a more competitive price estimate, etc.). Accordingly, the opportunity capture module 140 may inform the decision-making needed to capture the potential business lead and make a preliminary decision relating to a bid amount to submit in response to the potential lead and maximize a likelihood that the potential lead will produce a business win.

In one implementation, the proposal development module 150 may be invoked in response to the opportunity capture module 140 making the preliminary decision relating to the bid amount to submit in response, to the potential lead. In particular, the proposal development module 150 may generally leverage the documents, data, and other information captured in the proposal intelligence 110 to provide high-quality reference materials that may be used to support efforts to develop a proposal document and manage tasks associated therewith. In one implementation, the proposal development module 150 may therefore draw upon enterprise-wide resources to validate the baseline strategy and preliminary bid decision made with the opportunity capture module 140 to develop a proposal strategy likely to win the business opportunity. For example, the proposal development module 150 may collate information relating to marketing, human resources, past proposals and contracts, resource planning, operations, procurement, finance, and other enterprise areas to prepare a proposal that best responds to requirements or other needs that the potential customer specified in the Request For Proposals or other work solicitation. To that end, the proposal development module 150 may generally support the efforts to develop the proposal document and manage tasks associated therewith in multiple phases, which may generally include proposal planning and proposal preparation phases.

More particularly, the proposal planning phase managed via the proposal development module 150 may be used to initially form, train, or otherwise plan proposal teams that include human resources or other personnel that will collaboratively perform various tasks to validate and plan strategies to prepare the proposal. To that end, the proposal development module 150, may manage one or more workflows to coordinate interaction among the personnel in the proposal teams, wherein the workflows may manage various tasks to review lessons learned from business opportunities that were pursued in the past, proposals that were prepared and submitted in response to the business opportunities pursued in the past, and outcomes associated therewith (e.g., whether the proposals resulted in business wins or losses, factors that led to the proposals resulting in business wins or losses, etc.). As such, the proposal teams may collaboratively review the lessons learned via the workflows to assess the baseline solution and pricing strategy made with the opportunity capture module 140, wherein the baseline solution and pricing strategy may be extended into a proposal strategy in response to the proposal team validating the baseline solution and pricing strategy. In response thereto, the proposal development module 150 may review the Request For Proposals or other materials that the potential customer provided in relation to the opportunity to extract requirements, requests, or other criteria associated with the opportunity and create a compliance matrix that can be referenced to ensure that the final proposal document properly addresses every requirement, request, or other criterion that the potential customer provided. For example, the proposal development module 150 may identify certain keywords in the opportunity materials that reflect potential requirements (e.g., “will,” “shall,” “must,” etc.), wherein the proposal development module 150 may pull context around the identified keywords from the opportunity materials to create, the compliance matrix. In one implementation, in response to suitably creating the compliance matrix, the proposal development, module 150 may then prepare writer packages to specify documents, data, or other information that the proposal will require in order to properly address all issues identified in the compliance matrix and create a draft executive summary to outline the baseline solution and proposal plan. In one implementation, to complete the proposal planning phase, the workflows managed via the proposal development module 150 may then schedule a kickoff meeting in which the proposal teams will collaboratively review and/or revise the proposal plan, validate and/or revise the preliminary bid decision, and initiate the proposal preparation phase.

In one implementation, in response to the proposal teams collaboratively reviewing the proposal plan and validating the preliminary bid decision, the proposal preparation phase may be initiated to prepare the proposal document that will be submitted in response to the business opportunity. In particular, the proposal preparation phase may generally include the proposal development module 150 using the workflows to coordinate interaction among the proposal teams to plan responses to all the issues identified in the compliance matrix, initiate detailed cost estimates relating to the baseline solution or offering described in the proposal plan, and update the draft executive summary if appropriate. In one implementation, the proposal development module 150 may then freeze the baseline solution or offering described in the proposal plan prior to subsequent efforts that will be used to actually develop the proposal document. In particular, in response to freezing the baseline solution or offering described in the proposal plan, the proposal development module 150 may then execute the workflows to coordinate various tasks in which the proposal teams may retrieve various documents, data, or other information captured in the proposal intelligence 110 (e.g., documents or materials from successful past proposals or suitably related to the present opportunity, which may therefore provide high-quality reference materials to prepare the present proposal document). In one imp, the personnel on the proposal teams may then use the retrieved documents, data, or other information to assemble and revise text associated with the present proposal document. In response to the proposal teams approving the revised text associated with the proposal document, materials that make up the proposal document may be merged and custom cover pages, fonts, and other formatting may be combined therewith to create the final proposal document, which the proposal development module 150 may then submit in response to the Request For Proposals or other business opportunity.

Accordingly, the proposal development module 150 may generally manage various workflows, tasks, documents, data, and other information to support the proposal planning and proposal preparation phases and thereby ensure that the enterprise can suitably respond to the requirements, requests, needs, or other criteria that the potential customer specified. For example, and among other things, the proposal development module 150 may evaluate submission deadlines, bid or no-bid issues, bid schedules, the compliance matrix, or other issues to oversee and implement the proposal strategy developed to win the opportunity. In particular, the proposal development module 150 may manage various workflows that assign resources, documents, tasks, deliverables, or other proposal materials to personnel on the proposal teams and provide status updates to the personnel on the proposal teams to coordinate collaboration schedules and meetings that relate to planning and preparing the proposal within the enterprise. In addition, to oversee and implement the proposal strategy, the proposal development module 150 may specify what needs to be written and when, develop outlines, storyboards, and checklists, organize reviews and submissions, or manage any other tasks suitably necessary to ensure that the proposal document will have timely, comprehensive, and competitive responses. The proposal development module 150 may further assimilate new materials with best practices, graphics, boilerplate language, reviews, and other existing materials to simplify the processes in which the proposal teams will draft the production proposal and coordinate workflows to validate the production proposal against the compliance matrix. As such, the proposal development module 150 may have various built-in mechanisms to identify and correct errors or missing elements in, the production proposal, clarify and change requirements associated with the opportunity if appropriate, and distribute status reports among the proposal teams to ensure consistent collaboration and teamwork.

In one implementation, the post-submission module 160 may be invoked in response to the proposal development module 150 having validated the proposal strategy and pricing decision and then, submitting the production or final proposal document in response to the business opportunity (e.g., to the potential customer that released the business opportunity or another suitable location where proposals responding to the business opportunity are to be submitted). For example, in one implementation, the post-submission module 160 may manage one or more workflows to coordinate collaboration among personnel designated to respond to any questions that the potential customer may have in relation to the proposal that was submitted in response to the opportunity, wherein the workflows may further coordinate an oral presentation to the potential customer in association with the submitted proposal. In one implementation, in response to the potential customer rejecting the submitted proposal, requesting revisions, or otherwise requesting further action on the proposal, the workflows may appropriately invoke the business development module 130 or the proposal development module 150 to update and resubmit the proposal. For example, if the potential customer was not suitably satisfied with any proposals submitted in response to the opportunity and therefore opens re-competing associated therewith, the post-submission module 160 may invoke the proposal development module 150 to update and resubmit the proposal and update the proposal strategy to reflect any reasons relating to why the potential customer was dissatisfied with the previously submitted proposals. In another example, if a previously pursued proposal opportunity covered a particular term and ultimately ended in the enterprise losing the opportunity, the post-submission module 160 may track the status associated with the original term and invoke the business development module 130 if the customer has opened the proposal opportunity to re-compete in the new (current) term. As such, business development or other personnel teams may compare the previous proposal that resulted in the loss to the proposal that won the original term, which may inform whether the enterprise has a chance to win the opportunity in the new term and dramatically increase the likelihood that the enterprise will win the opportunity if pursued. Additionally, the business development or other personnel teams may review the customer intelligence 115a, competitor intelligence 115b, or any other suitable proposal intelligence 110 to inform the decision-making about whether to pursue the opportunity in the new term and how to better serve the needs associated with the customer and differentiate the previous winning competitor if pursued.

In one implementation, the workflows managed via the post-submission module 160 may alternatively coordinate contract negotiations between the enterprise and the potential customer if the potential customer accepts the proposal and therefore awards the contract to the enterprise and becomes an actual customer. Moreover, the workflows may coordinate collaboration among personnel teams associated with the enterprise, the customer, and any partners that will work with the enterprise and the customer to deliver on the awarded contract. For example, the workflows may coordinate timelines, milestones, deadlines, and other scheduling issues and share personnel calendars, timesheets, task lists, evaluations, resume materials, or other personnel management data among the personnel teams associated with the enterprise, the customer, and the partners to ensure proper and timely delivery on the contract. Additionally, in one implementation, the workflows may coordinate meetings and other suitable tasks to conduct a debriefing with the customer once the contract has been delivered, performed, or otherwise completed and obtain any documents, data, or other information to perform a closeout on the contract. The post-submission module 160 may then review the documents, data, and other information created, referenced, or otherwise used during the full proposal lifecycle (i.e., from originally reviewing the opportunity in the business development phase to make a pursuit decision through performing closeout on the strategy, the proposal, or any contract awarded thereon in the post-submission phase).

In particular, the post-submission module 160 may review the documents, data, and other information created, referenced, or otherwise used during the full proposal lifecycle to conduct lessons learned and appropriately update the proposal intelligence 110 that may be used to manage subsequent proposal lifecycles. For example, in one implementation, the post-submission module 160 may update the information captured in the proposal intelligence 110 in response to the workflows that coordinate the collaboration relating to responding to questions from the potential customer, conducting the oral presentation to the customer, managing any contract that the enterprise may be awarded on the contract, and managing the post-process review associated therewith. For example, in one implementation, the post-submission module 160 may archive materials that were created, revised, referenced, or otherwise used in the business development module 130, the opportunity capture module 140, or the proposal development module 150 during the proposal lifecycle to update the proposal intelligence 110. Accordingly, the post-submission module 160 may closeout any strategies and plans that were developed, created, or otherwise used therein and thereby add information associated with the current proposal lifecycle to the proposal intelligence 110 to provide reference materials may be leveraged or otherwise used to manage any phase associated with any subsequent proposal lifecycles. Accordingly, the post-submission module 160 may coordinate and perform post-process review on any suitable phase associated with the proposal lifecycle, including tasks, schedules, and other resources relating to the proposal and any contract awarded thereon and proposals or other materials that competitors submitted in response to the opportunity, whereby the updated proposal intelligence 110 may provide reference materials to differentiate approaches relating to how the enterprise and competitors developed the proposals and solutions and factors that impacted the decision-making leading to the customer awarding the opportunity to the enterprise or a competitor. As such, the information differentiating the approaches and impacting factors may update and enhance the proposal intelligence 110 to manage or otherwise inform subsequent proposal lifecycles.

In one implementation, the architecture 100 shown in FIG. 1 and described herein may further include a third party interface 170 that can support communication, interaction, or other collaboration among the enterprise, partners or vendors that work with the enterprise, and the customer. For example, if the enterprise will be a prime contractor delivering the solution described in the proposal, the enterprise may use the third party interface 170 to request related services from the partners or vendors that may potentially become sub-contractors, verify that the partners or vendors have capabilities to meet the needs that would be required from potential sub-contractors, and provide analytics relating to the capabilities associated with the partners or vendors (e.g., average times to respond, whether the third parties have actually met required needs in prior business cases, performance reports from other third parties, etc.). Similarly, if the enterprise will be a sub-contractor, the enterprise may receive related service requests from the prime contractor via the third party interface 170 and send responses or other services to the prime contractor via the third party interface 170. Furthermore, if the potential customer accepts the proposal that the enterprise submits and awards the contract to the enterprise (therefore becoming an actual customer), the customer may use the third party interface 170 to request or retrieve reports relating to performance under the contract via self-service. Moreover, the third party interface 170 may provide access points that the customer, prime contractor, and any sub-contractors can use to interact, interface, or otherwise collaborate to coordinate and manage performance under the contract. For example, in one implementation, the third party interface 170 may provide a call center that the partners, vendors, or customer can use communicate with the enterprise or one another and share timelines, milestones, deadlines, schedules, calendars, timesheets, task lists, or any other suitable data that may relate to the proposal or the contract awarded thereon.

In one implementation, as noted above, the various modules 130-160 associated with the proposal management system 120 and the Request For Proposals module 180 may be used to create various documents associated with the proposal lifecycle. For example, in one implementation, the Request For Proposals module 180 may be used to create a Request For Proposals document or other listing to solicit work from third parties, the business development module 130 may be used to create documents describing proposal intelligence, strategic plans, or other suitable information associated with a pursuit decision made in response to a particular business opportunity, the opportunity capture module 140 may be used to create documents describing resource and financial plans and strategies underlying a preliminary bid decision relating to a pursued opportunity, the proposal development module 150 may be used to create proposal documents that will be submitted in response to the pursued opportunity, and the post-submission module 160 may be used to create contract documents, debriefing materials, and other post-process review subsequent to having submitted the proposal document in response to the opportunity. In one implementation, the documents described above should be considered exemplary only, in that the architecture 100 may be suitably used to create any suitable document that relates to any task or phase associated with the proposal lifecycle. Accordingly, the architecture 100 may include various document creation tools to simplify and streamline the processes that the enterprise follows to create the documents that relate to tasks or phases associated with the proposal lifecycle.

For example, in one implementation, the document creation tools may include an obtain content feature that provides a drag-and-drop interface to search selected libraries 110 or other data sources in the proposal intelligence 110 to retrieve documents, materials, or other materials relating to past proposals, proposal sections or clauses, boilerplate language, business development, best-in-class products, licenses, consulting, public policy statements, asset purchases, indemnification, business separation, organization charts, manufacturing, corporate performance specifications, subcontractor limitations, reporting structures and guidelines, or any other suitable documents, material, or content captured in the proposal intelligence 110 that may relate to the particular document under development. In one implementation, one or more documents identified in the libraries or other sources in the proposal intelligence 110 may then be selected and placed into a target workspace, which may preserve a consistent data location associated with the document under development. Alternatively, in one implementation, the documents identified in the libraries or other sources in the proposal intelligence 110 may be suitably delivered to a location outside a workspace and subsequently loaded into the workspace in response to personnel completing work to revise or otherwise work on the documents. In one implementation, in response to personnel suitably completing the work to revise or otherwise create the document, a document merge feature may be used to save substantial time and substantially simplify potentially cumbersome processes otherwise used to create the document. In particular, in response to the personnel completing the work to obtain the documents, materials, and other content associated with the current document and suitably revising the text associated therewith or other completing work on the current document, the document merge feature may be invoked to make one or more mass changes that tailor the various documents, materials, and other content selected, revised, and used in the document to the current business opportunity. For example, all occurrences naming a previous customer or other entity across all the documents, materials, and other content used in the current document may be automatically replaced with the name associated with the potential customer on the current opportunity. Further, certain words or phrases may be replaced to mitigate risk in the manner noted above, certain character codes may be deleted to provide consistent formatting (e.g., removing all “̂m” characters to delete page breaks), or any other suitable changes that tailor the document to the current opportunity may be made across all the selected documents, materials, and other content used therein. In one implementation, all mass changes made to the document may be tracked and pulled to show context around the changes, which may enable personnel to approve or reject the changes.

In one implementation, once all selected documents, materials, and other content have been added to the workspace or other location to manage the document, appropriately revised or otherwise tailored to the current opportunity, and all changes have been appropriately approved or rejected, a personnel team member may use the document merge feature to specify an order in which the documents, materials, or other content will be used in the final document, provide a name and storage location associated with the final document, specify another personnel team member to manage a next workflow step to update or approve the document, or otherwise specify information to manage the document. The document merge feature may then combine the various selected documents, materials, and other content according to the specified order, add custom cover pages, fonts, and other formatting to assemble the final document, store the named document in the appropriate location, deliver the document to the next personnel team member associated with the workflow, or otherwise apply any instructions to manage the document. Furthermore, in one implementation, the document merge feature may generate an estimated page count associated with the final document that may be reviewed prior to combining the documents, materials, and other content to assemble the final document (e.g., if the potential customer specified a proposal page limit in the Request for Proposals, the estimated page count may be reviewed to ensure that the final proposal document will adhere to the page limit). In one implementation, the document merge feature may be suitably executed at scheduled times, manually, or in response to certain events or conditions (e.g., once a team member has completed a particular task associated with developing the document). The final document may then be reviewed and all changes and comments thereto may be rolled up to create a summary that describes how the document was created and tailored to the current opportunity.

In one implementation, the document creation tools may further include a shredder/requirements finder that the proposal development module 150 can use to search Request For Proposals content or other materials relating to a currently pursued business opportunity to identify certain keywords that represent potential requirements, requests, or other criteria that the potential customer specified therein. In one implementation, the shredder/requirements finder may then pull any sentences, paragraphs, or other textual context that contain the keywords identified in the Request For Proposals content or other materials to create a compliance matrix associated with the proposal document that will be submitted in response to the opportunity. As such, the compliance matrix may be referenced during the proposal development phase to ensure that the proposal document properly addresses all issues identified in the compliance matrix, wherein the proposal development module 150 may restrict submitting the proposal document until the proposal document has been properly validated to address all issues identified in the compliance matrix (e.g., coordinating workflows among the personnel teams to resolve any issues that have not been addressed, submitting the proposal document in response to validating that the proposal document addresses all issues in the compliance matrix, etc.). Additionally, in one implementation, the shredder/requirements finder may be used to mitigate risk, wherein certain words that have the potential to introduce risk to the enterprise may be located and replaced across various documents that will be used in the final proposal document or final contract document. For example, the shredder/requirements finder may identify any phrases that contain the term “shall,” “must,” or another word that carries potential risk, wherein the terms in the identified phrases may be automatically changed to “may,” “will endeavor to,” or other terms that may mitigate risk to the enterprise. Alternatively, the identified phrases that contain the risk words may be presented to team members to review and make changes to words having less where appropriate.

In one implementation, in addition to the document creation tools described above, the modular architecture 100 may include a promote lifecycle feature that controls whether a particular business opportunity can be promoted from a current phase in the lifecycle to a next phase in the lifecycle. In particular, the promote lifecycle feature may define required documents, required tasks, and any other custom requirements that must be completed before the business opportunity can be promoted from the current phase to the next phase to provide control over the proposal lifecycle progresses. For example, the promote lifecycle feature may require certain documentation to support the decision-making that resulted in a pursuit recommendation before the architecture 100 permits promoting the opportunity from the business development module 130 to the opportunity capture module 140. Further, in one implementation, the post-submission module 160 may include analytic tools to leverage any documents, data, or other information generated or used throughout the proposal lifecycle to manage other business activities within the enterprise (e.g., analyzing the customer intelligence 115a, competitor intelligence 115b, and partner intelligence 115c to assess actual or potential conflicts of interest, business development trends that show how the architecture 100 may be producing business wins and therefore adding value to the enterprise, etc.).

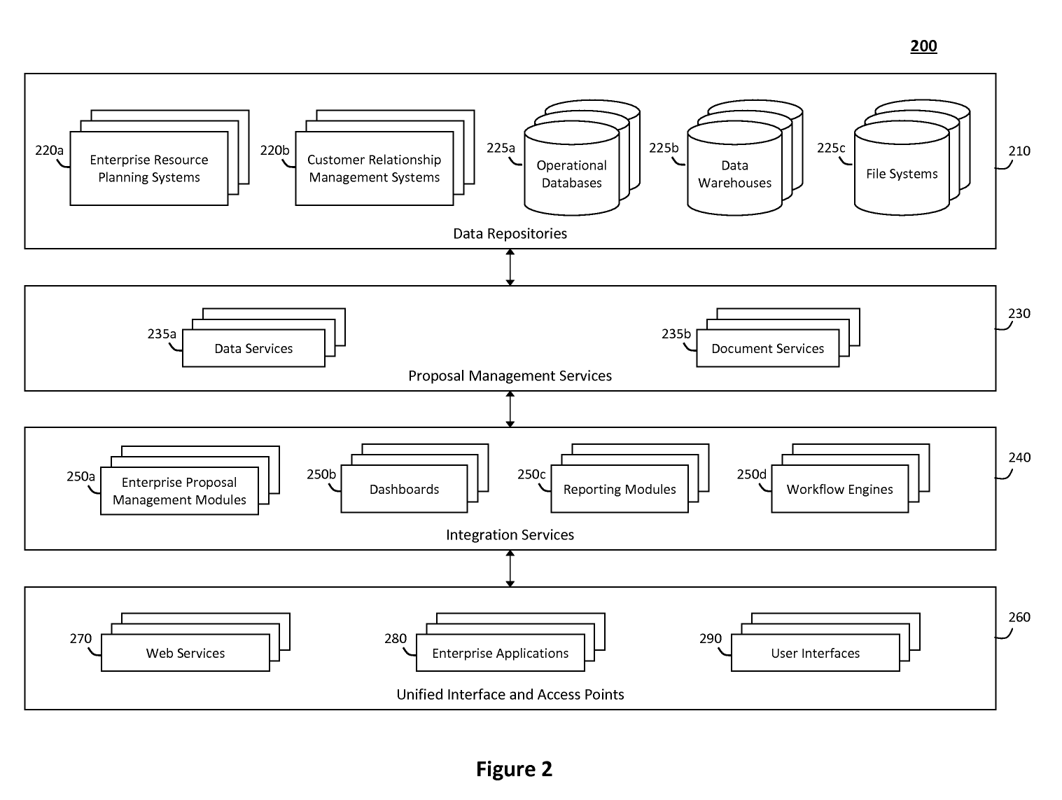

According to one aspect of the invention, FIG. 2 illustrates an exemplary service oriented architecture 200 that may implement the architecture associated with the enterprise proposal management system shown in FIG. 1 and described in further detail above. In particular, the service oriented architecture 200 shown in FIG. 2 may, be integrated with various third party tools, applications, and systems to provide capabilities that can be used to create and manage criteria and configurations associated with documents, data, and other information managed therein. As such, the integration with the third party tools, applications, and systems may seamlessly integrate third party products that may be familiar and known to end users into the enterprise proposal management system at an architectural level, which may further allow partners, vendors, customers, and other third parties to collaborate with the enterprise on a particular business opportunity, proposal, or contract via known and familiar web-based interfaces that can be used to share information, provide virtual meeting spaces, and leverage existing legacy systems.

Furthermore, as noted above, the service oriented architecture 200 may generally have a modular framework that allows the same product to contain all modules, interfaces, and other components associated therewith, whereby the same product can be shipped to any suitable entity that may desire to use the enterprise proposal management system integrated therewith. As such, the product shipped to a particular entity may have certain modules, interfaces, or other components enabled (i.e., the components that the entity desires to use or license), while any other modules, interfaces, or other components may be disabled within the shipped product (i.e., the components that the entity does not need or otherwise wishes to not license). For example, the product shipped to a certain entity that only plans to use the architecture 200 to generate Request For Proposals content may enable a Request For Proposals module 250a, a third party user interface 290, and any other components needed to support the enabled Request For Proposals module 250a and third party user interface 290 (e.g., certain Request For Proposals content and appropriate intelligence managed in the data repositories layer 210, certain data services 235a or document services 235b needed to interact with the enabled content managed in the data repositories layer 210, certain workflow engines 250 that the Request For Proposals module 250a needs to generate documents or contents, web services 270 that enable the third party user interface 290, etc.). Further, the product shipped to the entity that only plans to generate Request For Proposals content may have any other modules, interfaces, and other components that are needed to support the enabled modules, interfaces, and other components disabled. However, because the shipped product includes all the modules, interfaces, and other components associated with the architecture 200, the disabled modules, interfaces, and other components may simply be activated to enable use should the entity later desire to use the enterprise proposal management system to respond to work solicitations or other business opportunities released from third parties (i.e., rather than needing to have anew product shipped, tested, and integrated with the previously enabled features).

In one implementation, the service oriented architecture 200 shown in FIG. 2 may include a layered approach with various unified application program interfaces that integrate various modules, interfaces, and other components to enable seamless communication within the architecture 200. For example, in one implementation, the modules, interfaces, and other components associated with the architecture 200 may provide functionality to manage various data abstractions and documents that may relate to a proposal lifecycle. To that end, the architecture 200 may define a data object to represent each data abstraction and a document object to represent each document, wherein the data objects and document objects may be formatted with structured and descriptive metadata that can be managed via one or more services. In one implementation, the data abstractions and documents may be searchable or otherwise used via one or more user interfaces 290, which may include a search engine to communicate with one or more services or application program interfaces and thereby link the data abstractions and documents to various access points 260. In particular, as will be described in further detail herein, the architecture 200 may generally include a data repositories layer 210, an intermediate proposal management services layer 230, an intermediate integration services layer 240, and a unified interface and access points layer 260 that provide end users access to the functionality and data managed in the underlying layers.

In one implementation, the data repositories layer 210 may be organized and designed to provide a common center to share data among various knowledge-management systems, wherein the data repository layer 210 may organize data in one or more enterprise resource planning systems 220a, customer relationship management systems 220b, operational databases 225a, data warehouses 225b, and file systems 225c. In particular, the enterprise resource planning systems 220a may manage data associated with the enterprise via communication with the customer relationship management systems 220b, operational databases 225a, and data warehouses 225b to share data between different applications, modules, or other resources. In one implementation, the enterprise resource planning systems 220a may use the structured and descriptive metadata formatting to describe all documents and data that may pass there-through. For example, resume documents may include metadata fields that describe personnel names, titles, hire dates, expiration dates, projects, primary contact points, secondary contact points, proposals supported, job positions, certifications, branch offices, or other suitable personnel information. Similarly, best practice documents may include metadata fields that describe document names, titles, business units, summaries, client names, contract winners, bid numbers, proposal numbers, while contract documents may include metadata fields that describe document names, business units, start dates, end dates, auto renewal options, categories, industries, partners, partner managers, partner websites, final approvers, future negotiation notes, or any other suitable information. As such, the structured metadata may be used to describe every suitable document, proposal lifecycle task, or other data or information that relates to proposal management to map all needs that the enterprise may have to corresponding data abstractions or document objects and the user interfaces 290 may be customized to search, use, or otherwise interact with the various data abstractions and document objects. The enterprise resource planning systems 220a may therefore share information relating to the data abstractions and document objects across business units to increase efficiency and inform decision-making.

In one implementation, the data repositories layer 210 may manage one or more data centers associated with the enterprise, which may include the operational data repositories 225a to manage transactions and ongoing efforts and the data warehouses 225b to archive older data that may have value to audits, best practices, intellectual property, or other value. Moreover, the data repositories layer 210 may assign separate data stores to distinct business units within the operational databases 225a and data warehouses 225b, wherein the operational databases 225a may manage active workspaces, documents, or other materials associated with each business unit, while the data warehouses 225b may archive workspaces, documents, or other materials associated with each business unit. In one implementation, using the data warehouses 225b to archive information may offload data too old to reference actively and therefore reduce data bottlenecks while preserving content valuable from auditing, intellectual property, or other perspectives. Additionally, in one implementation, the customer relationship management systems 220b may further inform decision-making via analysis and details relating to customers, partners, vendors, competitors, suppliers, markets, finances, or other data relating to relationships with third parties. Thus, the data repositories layer 210 to collate and organize information that can inform analysis, strategic planning, and collaboration and provide efficient data management to drive the user interfaces 290 in a manner that can substantially that simplify various enterprise management needs.

In one implementation, the data repositories layer 210 may interface with the proposal management services layer 230, which may include one or more data services 235a and one or more document services 235b that link the shared data abstractions and document objects managed in the data repositories 210 with higher-level layers to present the data abstractions and document objects via end user interfaces 290. In one implementation, the data services 235a may own the data abstractions managed in the data repositories layer 210 and the document services 235b may own the document objects managed in the data repositories layer 210, wherein the ownership relationship may confer the data services 235a and the document services 235b the appropriate rights to create, update, delete, or otherwise managed the owned data abstractions and document objects. In one implementation, the data services 235a and the document services 235b may further reference the data abstractions and document objects, which may generally require communication with an owning proposal management service 230 to create, update, delete, or otherwise manage the referenced information. Thus, the data services 235a and document services 235b may own or reference the data abstractions and document objects managed in the data repositories layer 210 to create, use, delete, or otherwise manage the structured metadata that describes the properties associated with the data abstractions and document objects.

In one implementation, the integration services layer 240 may communicate with the proposal management services layer 230 to provide certain functionality, whereby the integration services layer 240 may own or reference the data abstractions and documents objects managed in the data repositories 210 layer via application program interfaces that pass messages through the proposal management services layer 2230. In one implementation, the functionality provided with the integration services layer 240 may include services that relate to one or more enterprise proposal management modules 250a (e.g., the Request For Proposals, business development, opportunity capture, proposal development, and post-submission modules shown in FIG. 1), one or more dashboards 250b, one or more reporting modules 250c, and one or more workflow engines 250d, which may be used to manage any suitable task that may occur in any suitable phase associated with a proposal lifecycle. For example, in one implementation, the dashboards 250b may provide target workspaces that relate to active projects, expiring content, pending tasks, upcoming meetings, or other proposal lifecycle management tasks, while the reporting modules 250c may manage debriefing or post-process analysis, customer presentations, competitor analysis, or any other information that may be shared or reported in relation to managing a particular proposal lifecycle. In one implementation, the workflow engines 250d may manage schedules, milestones, deadlines, due dates, collaborative interaction, pending deadline notifications, expiring content, specification changes, schedule changes, document creation, or other action items. Further, the various integration services 240 may enable collaborative interaction with external systems or third parties to share information between the enterprise and external content stores, data repositories, and other third party systems.

In one implementation, the integration services layer 240 may be coupled to the unified interface and access points layer 260, which may include various application program interfaces that can be used to reference or otherwise use the data abstractions and document objects managed in the data repositories layer 210. In particular, the unified interface and access points layer 260 may include one or more user interfaces 290 that can send and receive messages via the application program interfaces to reference or otherwise use the data abstractions and document objects managed in the data repositories layer 210 (i.e., via the integration services layer 240 and the proposal management services layer 230). Furthermore, in one implementation, the unified interface and access points layer 260 may include one or more web services 270 (e.g., peer-to-peer clients) and enterprise applications 280, which may be embedded within the user interfaces 290 to provide functionality that can be used to manipulate or otherwise control any suitable module, interface, component, or other resource associated with the architecture 200. Accordingly, the unified interface and access points layer 260 may integrate the architecture with legacy enterprise applications 280, which may include desktop software having options to search the data repositories layer 210 to obtain customer, partner, competitor, and performance intelligence, search libraries managed in the data repositories layer 210 to obtain documents or other materials that can be used to create new proposals, or otherwise manage other proposal lifecycle tasks. As such, the unified interface and access points layer 260 may be used to send intelligence, documents, materials, or other data obtained from the data repositories layer 210 via e-mail clients, lookup personnel information, share proposal sections using peer-to-peer technologies, or otherwise manage any suitable task in the proposal lifecycle. Moreover, in one implementation, informational flow at the user interfaces 290 may be driven via the structured metadata associated with the data abstractions and document objects managed in the data repositories layer 210, whereby the proposal management services 230, integration services 240, and appropriate application program interfaces may automatically populate and update the information shown via the user interfaces 290 in response to any changes that may occur in the data repositories layer 210.

In one implementation, the architecture 200 may be configured to apply role-based security to regulate access to the modules, interfaces, components, or other resources associated therewith. For example, in one implementation, proposal managers, team members, or other human resources having appropriate permissions may configure the role-based security to define access levels, access points, or other controls that limit access to the data abstractions, document objects, or other resources and functionality associated with the architecture 200. In one implementation, the role assigned to particular users may depend on user types, groups, or other specific permutations that may be defined. For example, an executive dashboard 250b may be configured to only permit access to certain users having an “executive” type, membership in an “executive” group, or other appropriate executive rights. In another example, certain projects may be assigned to certain users, whereby the role-based security may grant access to the projects to the assigned users. Thus, role-based permissions may be used in the architecture 200 to assign certain rights that permit access to certain data, documents, functionality, modules, interfaces, components, or other resources managed in the architecture 200. Furthermore, in one implementation, the unified interface and access points 260 may integrate any role-based security defined in the enterprise applications 280, third party systems, or other suitable resources that have role-based security controls.

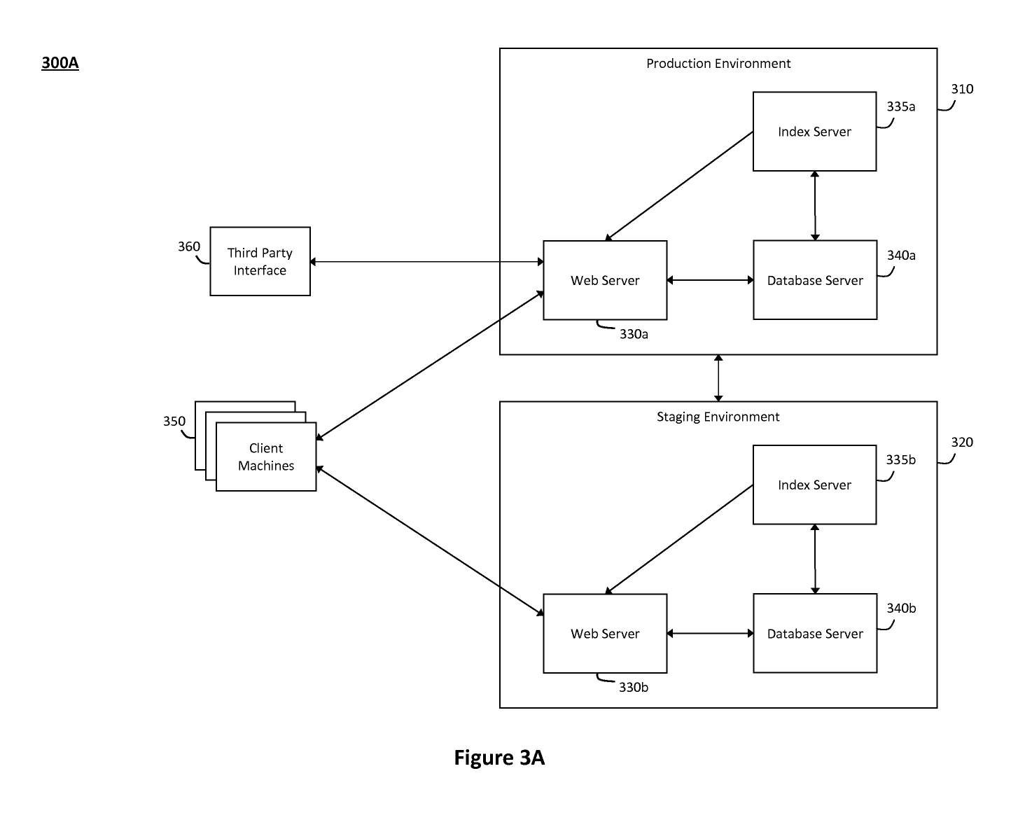

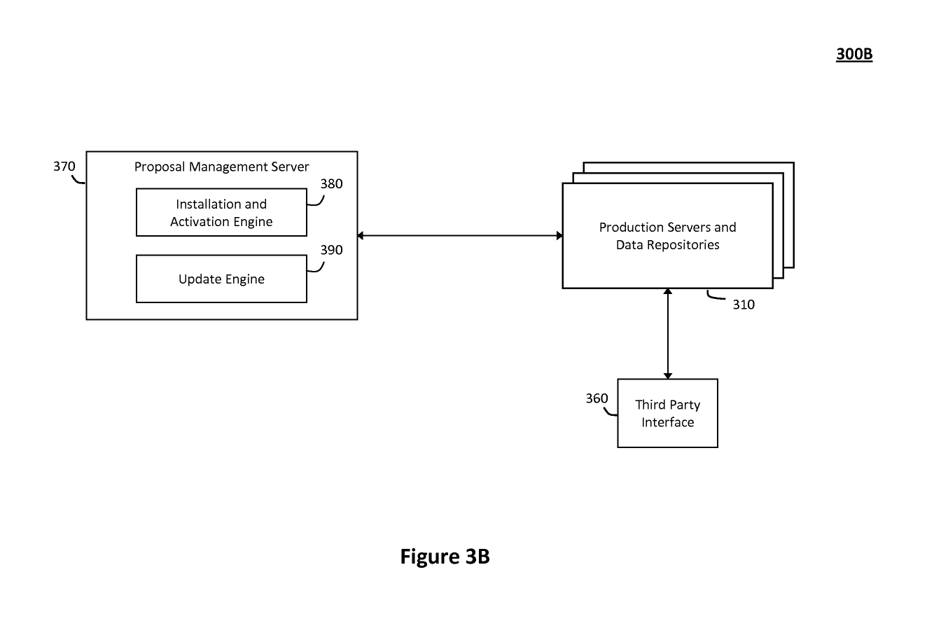

According to one aspect of the invention, FIG. 3A illustrates an exemplary enterprise ready environment 300A that may include a scalable staging (or sandbox) environment 320 and a scalable production environment 310 to manage and coordinate a proposal lifecycle. For example, in one implementation, the enterprise ready environment 300A may generally have the architectures shown in FIGS. 1 and 2 and described in further detail above deployed in a production environment 310, which may generally include a database server 340a to manage all data abstractions, document objects, and other documents, data, and information that can be used to manage proposal lifecycles. In one implementation, the production environment 310 may further include an index server 335a that manages the structured metadata to describe the data abstractions, document objects, and other documents, data, and information managed in the database server 340a, wherein the index server 335a may push information that relates to the managed metadata to a web server 330a that one or more client machines 350 access in order to interact with the proposal lifecycle management architecture deployed therein. Furthermore, in one implementation, the web server 330a may provide one or more access points associated with the third party interface 360 that partners and customers can use to collaborate with the enterprise that owns the production environment 310, and further to interact with the proposal lifecycle management architecture deployed therein via self-service.

In one implementation, the enterprise ready environment 300A may further include a staging environment 320, which may have a database server 340b, index server 335b, and web server 330b substantially identical or similar to the database server 340a, index server 335a, and web server 330a contained in the production environment 310. For example, in one implementation, the staging environment 320 may simulate the production environment 310 in order to manage developing, integrating, patching, or otherwise testing modifications to the proposal lifecycle management architecture prior to deploying or promoting the modifications to the production environment 310 that end users access to manage actual proposal lifecycles. In one implementation, the staging environment 320 to may further simulate the production environment 310 to enable demonstrations and training relating to the proposal lifecycle management architecture without disrupting or otherwise impacting live operations in the production environment 310. Accordingly, the staging environment 320 and the production environment 310 may generally have identical or substantially similar hardware and software configurations to enable quality assurance testing, performance capacity assurance, and other management relating to the proposal lifecycle management architecture prior to releasing the hardware and software configuration associated with the staging environment 320 into the production environment 310 where live operations occur. Further, in one implementation, the web server 330b associated with the staging environment 320 may provide one or more access points that the client machines 350 can use to perform user acceptance testing activities or otherwise interact with the hardware and software configuration associated with the staging environment 320 prior to updating the production environment 310 to reflect the hardware and software configuration associated with the staging environment 320.

According to one aspect of the invention, FIG. 3B illustrates an exemplary hybrid Software-as-a-Service (SaaS) environment 300B that may be used to manage and coordinate a proposal lifecycle. For example, in one implementation, the hybrid SaaS environment 300B may generally include a production environment 310 substantially similar, to the production environment 310 shown in FIG. 3A, wherein the production environment 310 shown in FIG. 3B may generally include one or more production servers and data repositories that mirror hardware and software configurations associated with the database server 340a, index server 335a, and web server 330a shown in FIG. 3A. Furthermore, in one implementation, one or more client machines within the enterprise (not shown) may access the proposal lifecycle management architecture deployed in the production environment 310 shown in FIG. 3A, which may further provide a third party interface 360 that partners and customers can use to collaborate with the enterprise that owns the production environment 310 and interact with the proposal lifecycle management architecture deployed therein via self-service.

However, in one implementation, the hybrid SaaS environment 300B may include a proposal management server 370 to manage developing, integrating, patching, or otherwise testing modifications to the proposal lifecycle management architecture prior to deploying or promoting the modifications to the production environment 310 that end users, partners, and customers access to manage actual proposal lifecycles. In particular, a third party software vendor that provides the proposal lifecycle management architecture to the enterprise may manage the proposal management server 370, which includes an update engine 390 to continuously maintain and remotely deploy updates to the architecture provided to the enterprise, while the enterprise controls the underlying infrastructure, security, access controls, intellectual property, on-boarding requirements, and other information technology policy issues associated with the production environment 310 and the information stored therein to manage proposal lifecycles. Furthermore, in one implementation, the proposal management server 370 may include an installation and activation engine 380 to install or activate features associated with the proposal lifecycle management architecture deployed in the production environment 310. For example, as noted above, the modular framework associated with the proposal lifecycle management architecture may allow the third party software vendor to ship the same product to any particular entity, wherein the shipped product may only enable the particular modules, interfaces, components, or other features that the particular entity desires to use (while any modules, interfaces, components, or other features not needed to use the enabled features may be disabled). As such, in one implementation, the hybrid SaaS environment 300B may have the installation and activation engine 380 automatically deploy and install updates to the proposal lifecycle management architecture into the production environment 310, except that the updates may only be activated in response to approval from the enterprise. Similarly, the enterprise may contact the third party software vendor to disable certain features that were previously enabled, enable features that were previously disabled, or otherwise modify the particular features associated with the proposal lifecycle management architecture that are enabled or disabled within the production environment 310. Accordingly, automatically installing updates via the hybrid SaaS environment 300B may enable the enterprise to eliminate or substantially reduce budgets otherwise required to update the proposal lifecycle management architecture and may further enable the enterprise to benefit from updated releases that reflect insights and best practices from other customers.

Those skilled in the art will recognize additional enhancements and configurations that may be used in the system and method described in further detail above. As such, the exemplary architectures, functionality, and other features associated with the system and method described in further detail above may be modified to manage any other suitable documents, tasks, systems, applications, data, information sources, or other resources that may have relevance to creating or otherwise managing work solicitations, proposals, contracts, or other documents that relate to managing business opportunities, and the system and method described above may therefore create or otherwise manage any additional metadata fields to suitably describe any data abstractions necessary to meet any particular needs that an enterprise may have in relation to managing business opportunities and proposal lifecycles.

Implementations of the invention may be made in hardware, firmware, software, or any suitable combination thereof. The invention may also be implemented as instructions stored on a machine-readable medium that can be read and executed on one or more processing devices. For example, the machine-readable medium may include various mechanisms that can store and transmit information that can be read on the processing devices or other machines (e.g., read only memory, random access memory, magnetic disk storage media, optical storage media, flash memory devices, or any other storage or non-transitory media that can suitably store and transmit machine-readable information). Furthermore, although firmware, software, routines, or instructions may be described in the above disclosure with respect to certain exemplary aspects and implementations performing certain actions or operations, it will be apparent that such descriptions are merely for the sake of convenience and that such actions or operations in fact result from processing devices, computing devices, processors, controllers, or other hardware executing the firmware, software, routines, or instructions. Moreover, to the extent that the above disclosure describes executing or performing certain operations or actions in a particular order or sequence, such descriptions are exemplary only and such operations or actions may be performed or executed in any suitable order or sequence.

Furthermore, aspects and implementations may be described in the above disclosure as including particular features, structures, or characteristics, but it will be apparent that every aspect or implementation may or may not necessarily include the particular features, structures, or characteristics. Further, where particular features, structures, or characteristics have been described in connection with a specific aspect or implementation, it will be understood that such features, structures, or characteristics may be included with other aspects or implementations, whether or not explicitly described. Thus, various changes and modifications may be made to the preceding disclosure without departing from the scope or spirit of the invention, and the specification and drawings should therefore be regarded as exemplary only, with the scope of the invention determined solely by the appended claims.

What is claimed is:

1. A system for creating documents to manage a proposal lifecycle, wherein the system comprises a document creation engine having one or more processors configured to:
retrieve, from one or more data repositories, data or documents that one or more inputs select to use in developing a proposal document associated with a current business opportunity, wherein the data or documents retrieved from the one or more data repositories relate to one or more past, present, or anticipated proposal opportunities;
replace instances where one or more keywords appear in all the data or documents retrieved from the one or more data repositories with one or more replacement terms; and
merge the data or documents retrieved from the one or more data repositories to assemble the proposal document in an order specified in the one or more inputs using a proposal template further selected in the one or more inputs, wherein the proposal document includes the one or more replacement terms to replace the instances where the one or more keywords appear in all the merged data or documents.

2. The system of claim 1, wherein the one or more processors are configured to replace the instances where the one or more keywords appear in all the data or documents retrieved from the one or more data repositories with the one or more replacement terms to mitigate potential risk associated with the proposal document, tailor the proposal document to the current business opportunity, or provide the proposal document with consistent formatting.

3. The system of claim 1, wherein the one or more processors are configured to merge the retrieved data or documents to assemble the proposal document at a scheduled time or in response to a manual request.

4. The system of claim 1, wherein the one or more processors are configured to merge the retrieved data or documents to assemble the proposal document in response to one or more workflows receiving an indication that personnel on one or more proposal teams have completed one or more tasks that relate to developing the proposal document.

5. The system of claim 4, wherein the one or more processors are further configured to:
place the data or documents retrieved from the one or more data repositories in a target workspace accessible to the personnel on the one or more proposal teams; and
manage the one or more workflows to coordinate the personnel on the one or more proposal teams collaboratively developing the proposal document.

6. The system of claim 5, wherein the target workspace provides a drag-and-drop interface that the personnel on the one or more proposal teams can use to select the data or documents to retrieve from the one or more data repositories, specify the one or more keywords and the one or more replacement terms, specify the order in which to merge the retrieved data or documents to assemble the proposal document, and select the proposal template associated with the proposal document.

7. The system of claim 5, wherein the one or more processors are further configured to:
track any changes that the personnel on the one or more proposal teams make to the data or documents placed in the target workspace; and
coordinate a review process to approve or reject the tracked changes, wherein the review process results in an authorization to submit the proposal document in response to the current business opportunity if the tracked changes are all approved or a requirement to revise the proposal document if any tracked changes are rejected.

8. The system of claim 1, wherein the one or more processors are further configured to:
search materials that a third party released to solicit work that relates to the current business opportunity to locate one or more requirements, requests, or criteria that the materials contain in relation to the current business opportunity;
create a compliance matrix to represent the one or more requirements, requests, or criteria that the materials contain in relation to the current business opportunity; and
validate whether the assembled proposal document addresses all the requirements, requests, or criteria in the compliance matrix.

9. The system of claim 8, wherein the one or more processors are further configured to:
authorize submitting the proposal document in response to the current business opportunity if the assembled proposal document addresses all the requirements, requests, or criteria in the compliance matrix; and
manage one or more workflows to revise the proposal document if the assembled proposal document does not address all the requirements, requests, or criteria in the compliance matrix, wherein the one or more workflows prevent submitting the proposal document in response to the current business opportunity until the assembled proposal document addresses all the requirements, requests, or criteria in the compliance matrix.

10. The system of claim 1, wherein the one or more processors are further configured to:
add custom content and formatting to the assembled proposal document; and
send the assembled proposal content with the added custom content and formatting to one or more predetermined locations.

11. A method for creating documents to manage a proposal lifecycle, comprising:
retrieving, from one or more data repositories, data or documents that one or more inputs select to use in developing a proposal document associated with a current business opportunity, wherein the data or documents retrieved from the one or more data repositories relate to one or more past, present, or anticipated proposal opportunities;
replacing, via a document creation engine having one or more processors, instances where one or more keywords appear in all the data or documents retrieved from the one or more data repositories with one or more replacement terms; and
merging, via the document creation engine, the data or documents retrieved from the one or more data repositories to assemble the proposal document in an order specified in the one or more inputs using a proposal template further selected in the one or more inputs, wherein the proposal document includes the one or more replacement terms to replace the instances where the one or more keywords appear in all the merged data or documents.

12. The method of claim 11, wherein the instances where the one or more keywords appear in all the data or documents are replaced with the one or more replacement terms to mitigate potential risk associated with the proposal document, tailor the proposal document to the current business opportunity, or provide the proposal document with consistent formatting.

13. The method of claim 11, wherein merging the retrieved data or documents to assemble the proposal document occurs at a scheduled time or in response to a manual request.

14. The method of claim 1, wherein the document creation engine merges the retrieved data or documents to assemble the proposal document in response to one or more workflows receiving an indication that personnel on one or more proposal teams have completed one or more tasks that relate to developing the proposal document.

15. The method of claim 14, further comprising:
placing, by the document creation engine, the data or documents retrieved from the one or more data repositories in a target workspace accessible to the personnel on the one or more proposal teams; and
managing the one or more workflows to coordinate the personnel on the one or more proposal teams collaboratively developing the proposal document.

16. The method of claim 15, wherein the target workspace provides a drag-and-drop interface that the personnel on the one or more proposal teams can use to select the data or documents to retrieve from the one or more data repositories, specify the one or more keywords and the one or more replacement terms, specify the order in which to merge the retrieved data or documents to assemble the proposal document, and select the proposal template associated with the proposal document.

17. The method of claim 15, further comprising:
tracking, via the document creation engine, any changes that the personnel on the one or more proposal teams make to the data or documents placed in the target workspace; and
coordinating a review process to approve or reject the tracked changes, wherein the review process results in an authorization to submit the proposal document in response to the current business opportunity if the tracked changes are all approved or a requirement to revise the proposal document if any tracked changes are rejected.

18. The method of claim 11, further comprising:
searching materials that a third party released to solicit work that relates to the current business opportunity to locate one or more requirements, requests, or criteria that the materials contain in relation to the current business opportunity;
creating a compliance matrix to represent the one or more requirements, requests, or criteria that the materials contain in relation to the current business opportunity; and
validating whether the assembled proposal document addresses all the requirements, requests, or criteria in the compliance matrix.

19. The method of claim 18, further comprising:
authorizing the proposal document for submission in response to the current, business opportunity if the assembled proposal document addresses all the requirements, requests, or criteria in the compliance matrix; and
managing one or more workflows to revise the proposal document if the assembled proposal document does not address all the requirements, requests, or criteria in the compliance matrix, wherein the one or more workflows prevent submitting the proposal document in response to the current business opportunity until the assembled proposal document addresses all the requirements, requests, or criteria in the compliance matrix.

20. The method of claim 11, further comprising:
adding custom content and formatting to the assembled proposal document; and
sending the assembled proposal content with the added custom content and formatting to one or more predetermined locations.
